(19) United States
(12) Patent Application Publication
(10) Pub. No.: US 2014/0102206 A1
(43) Pub. Date: Apr. 17, 2014

(54) PRESSURE MEASUREMENT DEVICE AND LIQUID TREATMENT DEVICE

(71) Applicant: Seiko Epson Corporation, Tokyo (JP)

(72) Inventor: Atsushi OSHIMA, Kanie-machi (JP)

(73) Assignee: Seiko Epson Corporation, Tokyo (JP)

(21) Appl. No.: 14/053,834

(22) Filed: Oct. 15, 2013

(30) Foreign Application Priority Data
Oct. 16, 2012 (JP) 2012-229057
Mar. 13, 2013 (JP) 2013-050265

(51) Int. Cl. G01L 7/08

(52) U.S. Cl. CPC G01L 7/08
USPC 73/715

(57) ABSTRACT

A pressure measurement device adapted to measure a pressure of a liquid includes a flow channel having a flow channel resistance, a liquid containing chamber having a predetermined capacity and communicating with the flow channel, a pressure changing section adapted to change a pressure of the liquid containing chamber, a measurement section adapted to measure a period from when a pressure wave of the liquid in the liquid containing chamber becomes a predetermined value to next time the pressure wave becomes the predetermined value, the pressure wave occurring when the pressure changing section is in operation in a state in which the liquid is contained in the flow channel and the liquid containing chamber, and an acquisition section adapted to obtain the pressure based on the period measured by the measurement section.

### CROSS-REFERENCE TO RELATED APPLICATIONS

This application claims priority to Japanese Patent Application No. 2012-229057 filed on Oct. 16, 2012 and to Japanese Patent Application No. 2013-050265 filed on Mar. 13, 2013. The entire disclosures of Japanese Patent Application No. 2012-229057 and Japanese Patent Application No. 2013-050265 are hereby incorporated herein by reference.

### BACKGROUND

1. Technical Field

The present invention relates to a technology for measuring the pressure of a liquid.

2. Related Art

In the past, as a technology for measuring the pressure of a liquid, there has been known a technology of, for example, JP-A-2010-85377 (Document 1). In Document 1, there is described a technology of measuring the pressure using a CI value (an equivalent series resistance) of a tuning-fork piezoelectric vibrator.

However, in the technology of the pressure measurement in Document 1, the CI value significantly depends on the physical property characteristics of the tuning-fork piezoelectric vibrator. Therefore, there has been pointed a problem that an extremely high accuracy is required in the manufacturing process in order to accurately measure the pressure. For example, it is required to control the shape and the size of the tuning-fork vibrator with high accuracy, or to accurately figure out and control the electrical characteristics of the tuning-fork vibrator. Further, there has been also pointed a problem that it is also required to frequently perform the calibration when using the tuning-fork vibrator. Since the behavior of the tuning-fork piezoelectric vibrator also fluctuates due to the influence of the dust in the air, there has been pointed a problem that a precise structure is required as the structure, and the use environment is limited. These problems have been common to the general technologies for measuring the pressure of a liquid. Besides the above, in the device for measuring the pressure of a liquid, there have been desired downsizing, cost reduction, resource saving, increase in easiness of manufacture, improvement in usability, and so on.

### SUMMARY

An advantage of some aspects of the invention is to solve at least a part of the problems described above, and the invention can be implemented as the following forms.

(1) An aspect of the invention provides a pressure measurement device adapted to measure a pressure of a liquid. The pressure measurement device includes a flow channel having a flow channel resistance, a liquid containing chamber having a predetermined capacity and communicating with the flow channel, a pressure changing section adapted to change a pressure of the liquid containing chamber, a measurement section adapted to measure a period from when a pressure wave of the liquid in the liquid containing chamber becomes a predetermined value to next time the pressure wave becomes the predetermined value, the pressure wave occurring when the pressure changing section is in operation in a state in which the liquid is contained in the flow channel and the liquid containing chamber, and an acquisition section adapted to obtain the pressure of the liquid based on the period measured by the measurement section. According to this pressure measurement device, since the pressure of the liquid is measured based on the period from when the pressure wave of the liquid occurring due to the change in pressure by the pressure changing section becomes a predetermined value to the next time the pressure wave becomes the predetermined value, it is possible to avoid the structural restrictions required when directly measuring the pressure to simplify the structure.

(2) Another aspect of the invention provides a pressure measurement device adapted to measure a pressure of a liquid. The pressure measurement device includes a flow channel having a flow channel resistance, a liquid containing chamber having a predetermined capacity and communicating with the flow channel, a pressure changing section adapted to change a pressure of the liquid containing chamber, a measurement section adapted to measure a period from when a pressure wave of the liquid in the liquid containing chamber becomes a first peak to next time the pressure wave becomes a second peak with a same polarity as the first peak, the pressure wave occurring when the pressure changing section is in operation in a state in which the liquid is contained in the flow channel and the liquid containing chamber, and an acquisition section adapted to obtain the pressure of the liquid based on the period measured by the measurement section. According to this pressure measurement device, since the pressure of the liquid is measured based on the period from when the pressure wave of the liquid in the liquid containing chamber occurring due to the change in pressure by the pressure changing section becomes a first peak to the next time the pressure wave becomes a second peak having the same polarity as the first peak, it is possible to avoid the structural restrictions required when directly measuring the pressure to simplify the structure. The period can also be arranged to be the period, for example, from when the pressure wave of the liquid in the liquid containing chamber becomes the local maximum due to the change in pressure to the next time the pressure wave of the liquid in the liquid containing chamber becomes the local maximum. Therefore, the pressure of the liquid can be measured using a relatively simple method.

(3) The pressure measurement device according to the above aspect of the invention may be configured such that the pressure changing section includes a piezoelectric element, and changes the pressure of the liquid containing chamber due to a force caused by a distortion of the piezoelectric element. According to this pressure measurement device, the pressure variation can electrically be controlled.

(4) The pressure measurement device according to the above aspect of the invention may be configured such that the piezoelectric element is further distorted due to a pressure variation of the liquid containing chamber, and the measurement section measures the period based on the distortion of the piezoelectric element. According to this pressure measurement device, the change in pressure of the liquid in the liquid containing chamber and the measurement of the period from when the pressure wave of the liquid becomes the predetermined value to the next time the pressure wave becomes the predetermined value can be performed using the single piezoelectric element.

(5) The pressure measurement device according to the above aspect of the invention may be configured such that the measurement section drives the piezoelectric element, detects a current flowing through the piezoelectric element, and measures the period based on the current flowing through the piezoelectric element. According to this pressure measurement device, the period from when the pressure wave of the liquid becomes the predetermined value to the next time the pressure wave becomes the predetermined value can be measured with relative ease.

(6) The pressure measurement device according to the above aspect of the invention may be configured such that the measurement section stops detecting the current flowing through the piezoelectric element while driving the piezoelectric element, and then detects the current flowing through the piezoelectric element after stopping driving the piezoelectric element. According to this pressure measurement device, since the detection of the current flowing through the piezoelectric element is stopped while driving the piezoelectric element, it is possible to reduce the drive loss due to the current detection to thereby improve the power consumption characteristics. Further, since the current flowing through the piezoelectric element is detected after terminating the drive of the piezoelectric element, it is possible to improve the S/N ratio in current detection without affecting the drive efficiency of the piezoelectric element.

(7) The pressure measurement device according to the above aspect of the invention may be configured such that the measurement section includes a resistor circuit adapted to measure the current flowing through the piezoelectric element, and a switch circuit adapted to control whether or not the current flowing through the piezoelectric element is made to flow through the resistor circuit. According to this pressure measurement device, by preventing the current flowing through the piezoelectric element from flowing through the resistor circuit while driving the piezoelectric element, and making the current flowing through the piezoelectric element to flow through the resistor circuit after terminating the drive of the piezoelectric element, whether or not the current detection is to be stopped can easily be selected. For example, it is also possible to arrange that the switch circuit is connected in parallel to the resistor circuit, and the current flowing through the piezoelectric element does not flow through the resistor circuit when the switch circuit is in the ON state. Further, for example, it is also possible to arrange that the switch circuit is connected in series to the resistor circuit, and the current flowing through the piezoelectric element does not flow through the resistor circuit when the switch circuit is in the OFF state.

(8) The pressure measurement device according to the above aspect of the invention may be configured such that the liquid is contained in a container, the liquid containing chamber communicates with one end of the flow channel, and the other end of the flow channel is connected to the container. According to this pressure measurement device, the pressure of the liquid contained in a container can be measured.

(9) The pressure measurement device according to the above aspect of the invention may be configured such that the other end of the flow channel is detachably connected to the container. According to this pressure measurement device, since it is possible to be detachably attached to the container, the pressure can easily be measured.

(10) Still another aspect of the invention provides a liquid treatment device employing the pressure measurement device. According to this liquid treatment device, it is also possible to directly perform the measurement without the intervention of the state in which the liquid is changed in state. Therefore, the restriction related to the measurement target or the measurement environment can be eased.

All of the constituents provided to each of the aspects of the invention described above are not necessarily essential, and in order to solve all or a part of the problems described above, or in order to achieve all or a part of the advantages described in the specification, it is possible to arbitrarily make modification, elimination, replacement with another new constituent, partial deletion of restriction content on some of the constituents. Further, in order to solve all or apart of the problems described above, or in order to achieve all or a part of the advantages described in the specification, it is also possible to combine some or all of the technical features included in one of the aspects of the invention with some or all of the technical features included in another of the aspects of the invention to thereby form an independent aspect of the invention. Further, according to such an aspect of the invention, it is possible to solve at least one of a variety of problems such as downsizing of the device, cost reduction, resource saving, enhancement of easiness of manufacturing, and enhancement of usability.

It should be noted that the invention can be put into practice in various forms. The invention can be put into practice in such a form as a pressure gauge, a hydraulic gauge, a water depth indicator, a pressure measurement system, or a pressure measuring method.

### BRIEF DESCRIPTION OF THE DRAWINGS

The invention will be described with reference to the accompanying drawings, wherein like numbers reference like elements.

FIG. 1 is an explanatory diagram for explaining a measurement system.

FIG. 2 is a block diagram for explaining a configuration of a drive circuit in a first embodiment of the invention.

FIGS. 3A through 3C are explanatory diagrams showing an example of a pressure signal and a detection signal.

FIG. 4 is a diagram showing an actual measurement result showing a relationship between a negative pressure period and the pressure in a container.

FIG. 5 is a block diagram for explaining a configuration of a drive circuit in a second embodiment of the invention.

FIGS. 6A through 6D are diagrams showing signal waveforms of the drive circuit.

FIGS. 7A and 7B are explanatory diagrams showing an example of a variation in internal pressure of a pump chamber.

FIG. 8 is a diagram showing an actual measurement result showing a relationship between a first period and the pressure in the container.

FIG. 9 is an explanatory diagram showing a configuration of a pressure measurement device as a modified example 2.

### DESCRIPTION OF EXEMPLARY EMBODIMENTS

Hereinafter, some preferred embodiments of the invention will be described in detail with reference to the accompanying drawings. It should be noted that the embodiments described below do not unreasonably limit the content of the invention as set forth in the appended claims. Further, it is noted that all of the constituents described below are not necessarily essential elements of the invention.

### A. First Embodiment

### A1. System Configuration

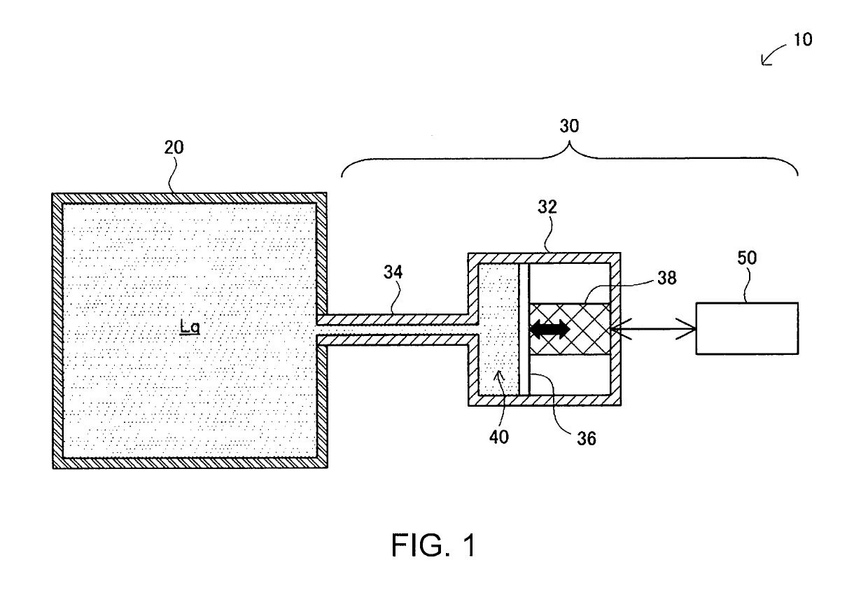

FIG. 1 is an explanatory diagram for explaining a measurement system 10 using a pressure measurement device 30 according to a first embodiment of the invention. The pressure measurement device 30 is a device for measuring the pressure of a liquid. The measurement system 10 is provided with a container 20 containing a liquid Lq as a measurement target, and the pressure measurement device 30. In the present embodiment, the liquid Lq contained in the container 20 is water. The inside of the container 20 is kept at a predetermined pressure.

The pressure measurement device 30 is provided with a housing 32, a flow channel 34, a diaphragm 36, a piezoelectric element 38, and a drive circuit 50. The housing 32 has a pump chamber 40 inside. The pump chamber 40 is constituted by an inner wall of the housing 32 and a diaphragm 36. The flow channel 34 is connected to the container 20 to make the pump chamber 40 and the container 20 communicate with each other. Therefore, the flow channel 34 and the pump chamber 40 are filled with the liquid Lq (water in the present embodiment) as the measurement target. The pump chamber 40 can also be provided with an air vent port attached with a lid for releasing the air, which exists in the pump chamber 40 before the measurement, in order to be filled with the liquid Lq. In the present embodiment, the container 20 and the housing 32 are each formed of an extremely hard material. For example, stainless steel can be adopted.

The piezoelectric element 38 is fixed to the diaphragm 36 in one end, and is fixed to an inner wall of the housing 32 in the other end, respectively. In the present embodiment, a laminate piezoelectric element is used as the piezoelectric element 38. Further, besides the above, it is also possible to arrange that a monomorph or bimorph piezoelectric element is adopted. The piezoelectric element 38 is connected to the drive circuit 50, and is expanded or contracted due to a drive signal (electrical power) applied from the drive circuit 50. The piezoelectric element 38 pushes or pulls the diaphragm 36 using the force caused by the distortion due to the expansion or the contraction to thereby vary the capacity of the pump chamber 40, and thus, indirectly increase or decrease the pressure to the water in the pump chamber 40. The diaphragm 36 and the piezoelectric element 38 correspond to a pressure changing section set forth in the appended claims.

The drive circuit 50 applies the drive signal to the piezoelectric element 38, and at the same time, detects the variation in the internal pressure of the pump chamber 40. Specifically, when the pressure of the pump chamber 40 varies, a force is applied to the piezoelectric element 38 via the diaphragm 36. The piezoelectric element 38 generates a voltage due to the piezoelectric effect. The drive circuit 50 detects the voltage generated by the piezoelectric element 38 to thereby detect the variation in the internal pressure of the pump chamber 40. As described later, the drive circuit 50 measures the behavior of the water as the measurement target based on the variation in the internal pressure of the pump chamber 40 detected under predetermined conditions.

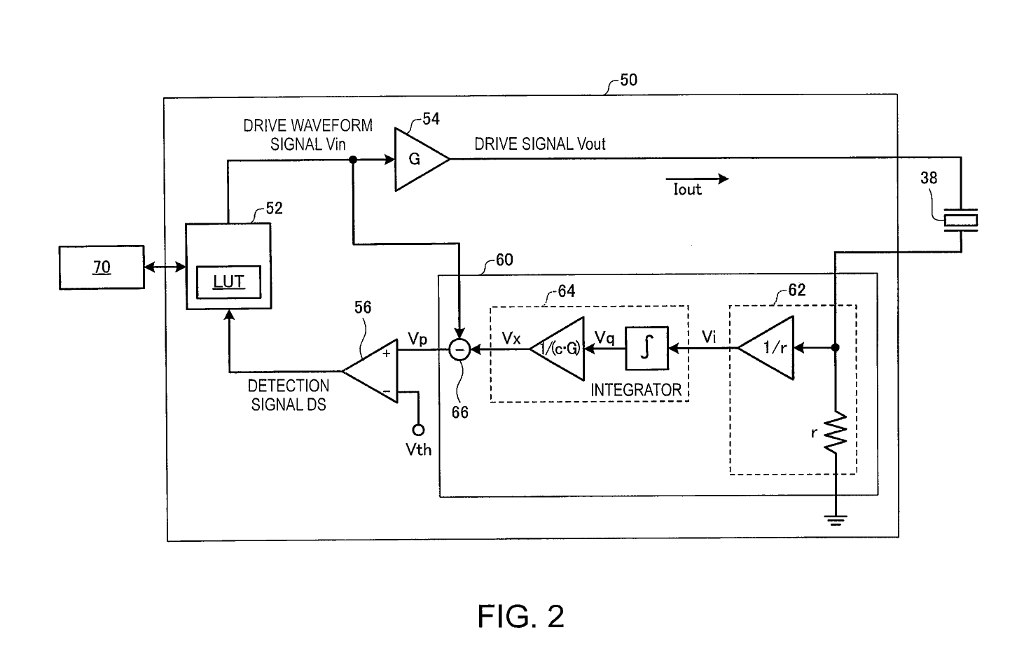

FIG. 2 is a block diagram for explaining a configuration of the drive circuit 50. The drive circuit 50 is provided with a control section 52 for outputting a drive waveform signal Vin, an amplifier circuit 54 for amplifying the drive waveform signal Vin at a gain G to output a drive signal Vout, a pressure detection section 60 for detecting an internal pressure of the pump chamber 40, a comparison section 56 for comparing the internal pressure thus detected with a predetermined threshold voltage, and a display section 70. The pressure detection section 60 is provided with a current detection circuit 62 for detecting a drive current of the piezoelectric element 38, an integration circuit 64 for integrating the drive current thus detected, and a subtraction circuit 66 for outputting the difference between an output of the integration circuit 64 and the drive waveform signal Vin.

The drive circuit 50 detects the pressure signal Vp representing the internal pressure of the pump chamber 40 in such a manner as described below. The control section 52 outputs the drive waveform signal Vin. The drive waveform signal Vin is amplified by the amplifier circuit 54, and is then applied to the piezoelectric element 38 as the drive signal Vout. On this occasion, the drive current lout corresponding to the drive signal Vout flows into one end of the piezoelectric element 38. One end of a resistor r used for current detection is connected to the other end of the piezoelectric element 38. The other end of the resistor r is connected to a reference potential. The current detection circuit 62 converts the electrical potential difference between the terminals of the resistor r generated by the drive current lout into a first signal Vi by dividing the electrical potential difference by the resistance value of the resistor r, and then input the result to the integration circuit 64. The integration circuit 64 integrates the first signal Vi thus input with an integrator to thereby output a charge signal Vq as a value corresponding to an amount of the charge stored in the piezoelectric element 38.

The drive current lout (the first signal Vi) flowing through the piezoelectric element 38 is proportional to the displacement speed of the piezoelectric element 38. Therefore, the amount (the charge signal Vq) of the charge stored in the piezoelectric element 38 is proportional to the displacement of the piezoelectric element 38. In the state in which the piezoelectric element 38 can freely expand or contract, the displacement of the piezoelectric element 38 is roughly proportional to the drive signal. Meanwhile, when the internal pressure of the pump chamber 40 changes, the change in pressure acts on the piezoelectric element 38 via the diaphragm 36. On this occasion, since the piezoelectric element 38 expands or contracts (changes in displacement) in proportion to the change in pressure received, the difference between the displacement of the piezoelectric element 38 in the case of being affected by the change in pressure in the pump chamber 40 and the original displacement of the piezoelectric element 38 (without being affected by the pressure) is proportional to the pressure (the internal pressure of the pump chamber 40) acting on the piezoelectric element 38.

The pressure detection section 60 divides the charge signal Vq, which is obtained by the integrator of the integration circuit 64, by an equivalent capacitance c of the piezoelectric element 38 and the gain G of the amplifier circuit to thereby obtain a voltage signal Vx. The voltage detection section 60 calculates the difference between the voltage signal Vx corresponding to the actual displacement of the piezoelectric element 38 and the drive waveform signal Vin with the subtraction circuit 66 to thereby obtain the pressure signal Vp corresponding to the internal pressure of the pump chamber 40.

The pressure detection section 60 inputs the pressure signal Vp thus obtained to the comparison section 56. The comparison section 56 compares the pressure signal Vp with the predetermined threshold voltage to thereby generate a binarized detection signal DS, and input the detection signal DS to the control section 52. The control section 52 is provided with a look-up table LUT. The control section 52 obtains the pressure of the water based on the detection signal DS thus input and the look-up table LUT. Then, the control section 52 displays the pressure value thus obtained on the display section 70 so as to be visually recognized by the user. It should be noted that the method of obtaining the pressure based on the look-up table LUT and the detection signal DS will be described later.

### A2. Pressure Oscillation

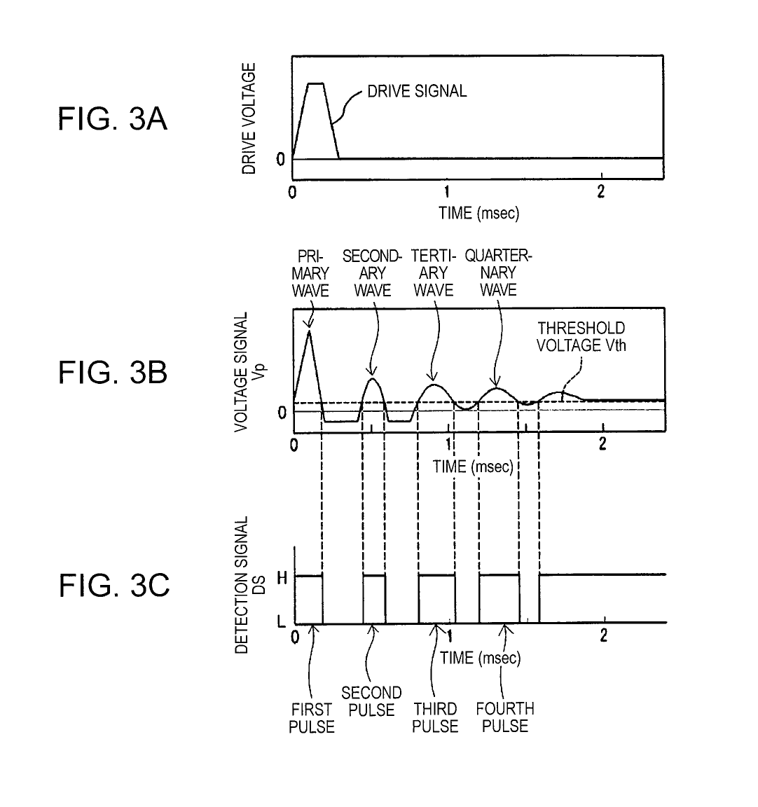

FIGS. 3A through 3C are explanatory diagrams showing an example of the pressure signal Vp obtained by the pressure detection section 60 and the detection signal DS obtained by the comparison section 56 when applying the drive signal Vout to the piezoelectric element 38. FIG. 3A shows the drive signal Vout to be applied to the piezoelectric element 38. FIG. 3B shows the pressure signal Vp obtained by the pressure detection section 60. FIG. 3C shows the detection signal DS obtained by the comparison section 56.

As shown in FIG. 3A, in the present embodiment, the control section 52 outputs the drive waveform signal Vin as a single pulse to thereby apply the drive signal Vout to the piezoelectric element 38. The piezoelectric element 38 expands when the voltage (the drive voltage) of the drive signal Vout rises, and pressurizes the liquid Lq in the pump chamber 40 via the diaphragm 36. As a result, as shown in FIG. 3B, the internal pressure of the pump chamber 40 rapidly rises in accordance with the rise in voltage of the drive signal Vout. In the period in which the drive voltage is kept at a high voltage, the displacement of the piezoelectric element 38 does not change. Therefore, the pressure difference occurs between the liquid Lq in the pump chamber 40 and the liquid in the container 20, and the liquid Lq flows out from the pump chamber 40 to the container 20 (see FIG. 1). The internal pressure of the pump chamber 40 decreases as the liquid Lq flows out to the container 20. On this occasion, an inertial force acts on the liquid Lq passing through the flow channel 34 due to the inertance of the flow channel 34, and the liquid Lq is urged to continue to flow from the pump chamber 40 to the container 20. As a result, the internal pressure of the pump chamber 40 becomes a pressure (negative pressure) lower than the pressure in the container 20, and further, when the internal pressure of the pump chamber 40 drops to a level approximate to the saturated vapor pressure of the liquid Lq (water in the present embodiment) as the measurement target, the cavitation occurs, and the internal pressure is kept roughly constant. It should be noted that the inertance will be explained later in detail.

Then, when the internal pressure becomes the negative pressure, the pump chamber 40 sucks the liquid Lq from the container 20. Therefore, the liquid Lq flows from the container 20 to the pump chamber 40. Also on this occasion, the liquid Lq is urged to continue to flow from the container 20 to the pump chamber 40 due to the inertial force based on the inertance of the flow channel as explained above. Therefore, as shown in FIG. 3B, the internal pressure of the pump chamber 40 rises. As described above, the internal pressure of the pump chamber 40 oscillates due to the inertial force caused by the inertance of the flow channel 34. As shown in FIG. 3B, the oscillation of the internal pressure of the pump chamber 40 has a predetermined period.

Here, as shown in FIG. 3B, a wave of the pressure oscillation, which is composed of single rise and single fall in the internal pressure of the pump chamber 40 due to the application of the drive signal Vout to the piezoelectric element 38, is referred to as a primary wave. The subsequent waves of the pressure oscillation following the primary wave are referred to as a secondary wave, a tertiary wave, a quarternary wave, and so on. As shown in FIG. 3C, the detection signal DS becomes a signal corresponding to the waves (the primary wave, the secondary wave, and so on) of the pressure oscillation of the pump chamber 40. The pulses of the detection signal DS corresponding respectively to the waves of the pressure oscillation are referred to as a first pulse, a second pulse, and so on.

As shown in FIG. 3C, in the case in which the second pulse is detected subsequently to the first pulse of the detection signal DS, the length of the period from when the first pulse is generated to when the second pulse is generated includes information related to the pressure of the liquid Lq in the container 20. The secondary wave of the pressure signal Vp is generated by the phenomenon that the liquid Lq, which is flowing through the flow channel 34 from the pump chamber 40 toward the container 20, is pulled back to the pump chamber 40 due to the pressure difference between the pump chamber 40 and the container 20. Therefore, since the force of the pump chamber 40 for pulling back the liquid Lq in the container 20 increases as the pressure difference between the pump chamber 40 and the container 20 increases, the secondary wave occurs early, and as a result, the second pulse in the detection signal DS is also generated early.

As shown in FIG. 3B, in the period from the end of the primary wave to the generation of the secondary wave, the inside of the pump chamber 40 is kept at roughly the saturated vapor pressure of the liquid Lq. Further, since the liquid Lq is not input to or output from the pump chamber 40 except the communication with the container 20, there is no chance for the pressure of the pump chamber 40 to dramatically vary in the period until the secondary wave occurs. Therefore, the pressure difference between the container 20 and the pump chamber 40 in the period (hereinafter also referred to as a negative pressure period T) from the end of the primary wave to the generation of the secondary wave is mainly determined by the pressure in the container 20. Specifically, as the pressure in the container 20 rises, the negative pressure period T shortens. In other words, it can be said that the shorter the negative pressure period T is, the higher the pressure of the container 20 is. Further, according to an experiment, it is confirmed that the period from the generation to the end of the primary wave, namely the pulse width of the first pulse, does not depend on the pressure of the pump chamber 40, and hardly varies.

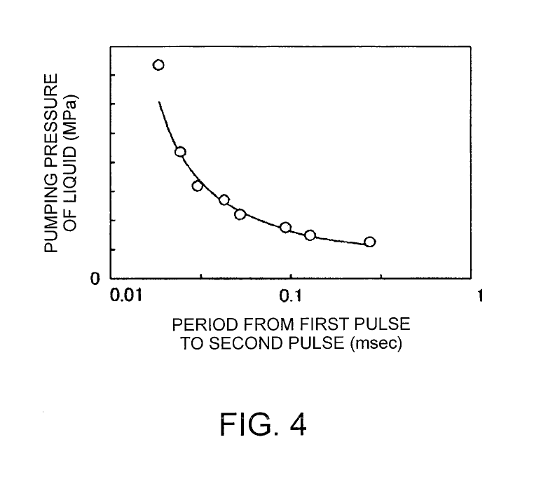

Then, the fact that the negative pressure period in the pump chamber 40 depends on the pressure of the container 20 will be shown using the actual measurement. Specifically, the fact that the negative pressure period T shortens as the pressure in the container 20 rises will be shown. FIG. 4 is a diagram showing an actual measurement result showing a relationship between the negative pressure period T between the first pulse and the second pulse, and the pressure in the container 20. In the graph of FIG. 4, the horizontal axis represents the negative pressure period T, and the vertical axis represents the pressure of the container 20. In the present experiment, the pressure of the container 20 is measured by a pressure gauge disposed separately. As shown in FIG. 4, it is understood that the negative pressure period T shortens as the pressure of the container 20 rises. In other words, by detecting the negative pressure period T, the pressure of the liquid Lq (the container 20 in the present embodiment) as the measurement target can be detected.

### A3. Pressure Measurement

The control section 52 measures the negative pressure period T from when the pressure wave of the liquid Lq, which occurs when the diaphragm 36 and the piezoelectric element 38 are in operation in the state in which the liquid Lq is contained in the flow channel 34 and the pump chamber 40, becomes a predetermined level to the next time the pressure wave becomes the predetermined level, and then obtains the pressure of the liquid Lq based on the negative pressure period T. In the present embodiment, the pressure measurement device 30 has the look-up table LUT corresponding to the graph shown in FIG. 4 explained above stored in the control section 52 (see FIG. 2). In other words, the control section 52 is provided with the look-up table LUT including the values of the negative pressure period T and the values based on the actual measurement of the pressure of the measurement target corresponding to each other. When actually measuring the pressure of the liquid Lq as the measurement target, the control section 52 applies a pulse of drive signal Vout to the piezoelectric element 38 to thereby generate the pressure oscillation in the pump chamber 40, and then extracts the negative pressure period T from the detection signal DS thus detected. Then, the control section 52 inputs the negative pressure period T thus obtained to the look-up table LUT. The control section 52 obtains the value of the pressure output from the look-up table LUT in correspondence with the negative pressure period T.

Subsequently, the control section 52 displays the value of the pressure thus obtained on the display section 70 so as to be visually recognized by the user. It is also possible to arrange that the control section 52 is provided with look-up tables LUT with respect to a variety of types of liquids such as water, predetermined oil, or a predetermined organic solvent. This can be realized by actually measuring the correlation between the negative pressure period T and the pressure of the liquid Lq as the measurement target to make the look-up table LUT with respect to each of the liquids.

Then, the inertance used in the explanation of the present embodiment will be explained. The inertance is a characteristic value of the flow channel. Specifically, the inertance represents how easy the liquid flows in the case in which the liquid in the flow channel is urged to flow due to the pressure applied to one end of the flow channel. For example, it is assumed that the flow channel having the cross-sectional area S and the length L is filled with a fluid (the liquid Lq in the present embodiment) with the density ρ, and the pressure P (the pressure difference between the both ends) is applied to one end of the flow channel. The force P×S acts on the fluid in the flow channel. As a result, the liquid Lq in the flow channel starts flowing. Assuming that the acceleration of the fluid is a, the motion equation represented by Formula (1) below is true.

P×S=ρ×S×L×a (1)

Assuming that the volume flow rate of the flow in the flow channel is Q, and the flow rate of the fluid flowing through the flow channel is v, Formulas (2) and (3) below can be obtained.

Q=v×S (2)

dQ/dt=a×S (3)

Formula (4) below can be obtained from Formulas (2) and (3).

P=(ρ×L/S)×(dQ/dt) (4)

Formula (4) shows that if the same pressure P is applied, the smaller the value (ρ×L/S) becomes, the larger the value (dQ/dt) becomes (i.e., the more significantly the flow rate varies). The value (ρ×L/S) is the value called the inertance. Hereinabove, the inertance is explained.

As described hereinabove, the pressure measurement device 30 can measure the pressure of the liquid Lq as the measurement target using the pressure oscillation between the container 20 and the pump chamber 40. Therefore, in the pressure measurement device 30, the pressure of the liquid Lq as the measurement target can be measured if it is possible to apply the drive signal to the piezoelectric element 38 to thereby generate the pressure oscillation between the pump chamber 40 and the container 20, and then obtain the variation in the internal pressure of the pump chamber 40. As described above, since the internal pressure of the pump chamber 40 is kept at the saturated vapor pressure of the liquid Lq, it results that the relative pressure from the saturated vapor pressure is measured in the “negative pressure period” which varies in accordance with the difference from the pressure of the liquid Lq as the measurement target. Therefore, since the “negative pressure period” is hardly affected by the characteristic variation of the piezoelectric element, the calibration of the piezoelectric element is not necessarily required. Further, the pressure measurement can be performed with a simple structure. As a result, it is possible to obtain a configuration, which is hardly affected by the variation in external environment of the pressure measurement device 30 such as external dust or the temperature variation when measuring the pressure, and has high durability. Therefore, the pressure measurement device 30 is capable of performing the pressure measurement even in a relatively poor measurement environment, and can therefore be made to be a pressure gauge most suitable for industrial use. For example, a tank for industrial use for containing a liquid, and a pipe as a flow channel of a liquid for industrial use are normally provided with a through hole for inserting a thermometer or a through hole for drain evacuation. By connecting the flow channel 34 of the pressure measurement device 30 to such through holes, it becomes possible to measure the pressure in the tank or the pipe. Further, in the present embodiment, since the single piezoelectric element 38 performs the application of the pressure to the pump chamber 40 and the measurement of the internal pressure of the pump chamber 40, simplification of the structure, downsizing, and cost reduction can be realized compared to the case of performing the above by separate elements or devices, respectively.

Regarding the correspondence relationship with the appended claims, the pump chamber 40 corresponds to a liquid containing chamber set forth in the appended claims. The diaphragm 36 and the piezoelectric element 38 correspond to the pressure changing section set forth in the appended claims. The piezoelectric element 38 and the drive circuit 50 correspond to a measurement section set forth in the appended claims. The drive circuit 50 (the control section 52) corresponds to an acquisition section set forth in the appended claims.

### B. Second Embodiment

### B1. System Configuration

Since the configuration of the measurement system 10 using the pressure measurement device 30 according to the second embodiment of the invention is substantially the same as that in the first embodiment (FIG. 1), the graphical description and the illustration thereof will be omitted. It should be noted that the second embodiment is different in the configuration of the drive circuit 50 from the first embodiment.

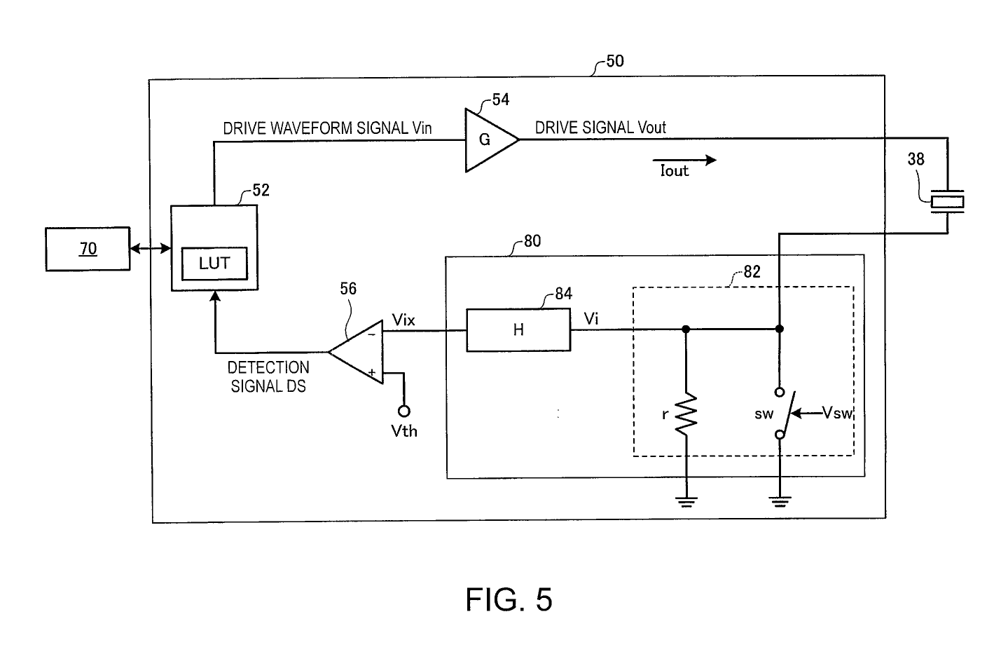

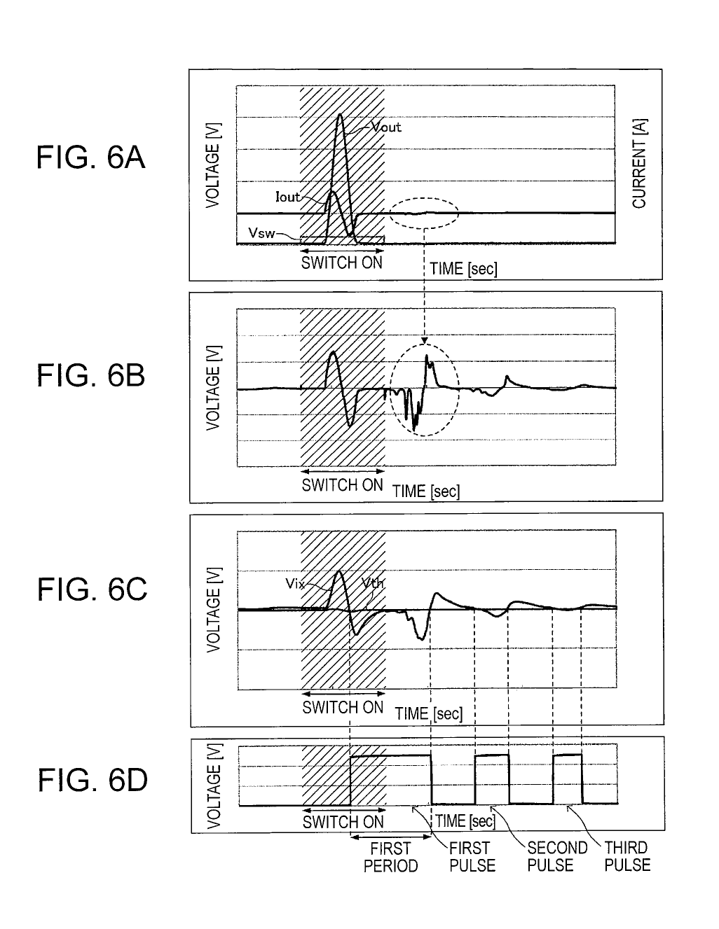

FIG. 5 is a block diagram for explaining the configuration of the drive circuit 50 in the second embodiment. Further, FIGS. 6A through 6D are diagrams showing signal waveforms of the drive circuit 50. The drive circuit 50 is provided with the control section 52 for outputting the drive waveform signal Vin, the amplifier circuit 54 for amplifying the drive waveform signal Vin at the gain G to output the drive signal Vout, a pressure variation rate detection section 80 for detecting a variation rate of the internal pressure of the pump chamber 40, the comparison section 56 for comparing the variation rate of the internal pressure thus detected with a predetermined threshold voltage Vth, and the display section 70. The pressure variation rate detection section 80 is provided with a current detection circuit 82 for detecting the drive current of the piezoelectric element 38, and a bandpass filter 84 for eliminating a DC component and high-frequency noise from a voltage signal representing the drive current thus detected.

The drive circuit 50 detects a second signal Vix representing the variation rate of the internal pressure of the pump chamber 40 in such a manner as described below. The control section 52 outputs the drive waveform signal Vin. The drive waveform signal Vin is amplified by the amplifier circuit 54, and is then applied to the piezoelectric element 38 as the drive signal Vout. On this occasion, the drive current lout corresponding to the drive signal Vout flows into one end of the piezoelectric element 38. One end of the resistor r used for current detection and one end of a switch sw are connected to the other end of the piezoelectric element 38. Both of the other end of the resistor r and the other end of the switch sw are connected to the reference potential. The switch sw is a switch turning ON/OFF in accordance with the voltage level of a control signal Vsw, and can be realized by, for example, inputting the control signal Vsw to the gate of a MOS transistor.

The control section 52 controls the voltage level of the control signal Vsw to output the drive waveform signal Vin while the switch sw is in the ON state, and thus, the drive signal Vout is applied to the piezoelectric element 38 and the drive current lout flows into the piezoelectric element 38. The control section 52 terminates the output of the drive waveform signal Vin, and then sets the switch sw to the OFF state. FIG. 6A shows an example of the waveforms of the drive signal Vout, the drive current lout, and the control signal Vsw.

The current detection circuit 82 converts the electrical potential difference generated by the drive current lout and the ON resistance of the switch sw while the switch sw is in the ON state, or the electrical potential between the terminals of the resistor r generated by the drive current lout while the switch sw is in the OFF state, into the first signal Vi, and then inputs the first signal Vi to the bandpass filter 84. FIG. 6B shows an example of a waveform of the first signal Vi.

The bandpass filter 84 transmits the signal in a desired frequency band included in the first signal Vi thus input to output the second signal Vix. The frequency band of the bandpass filter 84 is set so as to include the frequency band of the pressure oscillation of the pump chamber 40. FIG. 6C shows an example of waveforms of the second signal Vix and the threshold voltage Vth of the comparison section 56.

When the internal pressure of the pump chamber 40 changes, the change in pressure acts on the piezoelectric element 38 via the diaphragm 36. On this occasion, since the piezoelectric element 38 expands or contracts (changes in displacement) in proportion to the variation in pressure applied, the variation rate of the piezoelectric element 38 is proportional to the variation rate of the internal pressure of the pump chamber 40. In essence, the second signal Vix, which is obtained by converting the drive current lout into a voltage value, is a signal representing the variation rate of the internal pressure of the pump chamber 40. Therefore, the variation rate of the piezoelectric element 38, the variation rate of the internal pressure of the pump chamber 40, and the second signal Vix have a proportional relationship with each other. Therefore, when the second signal Vix is at the predetermined reference voltage, the variation rate of the internal pressure of the pump chamber 40 is equal to zero, namely, the internal pressure of the pump chamber 40 is at a peak (a local maximum or a local minimum). Here, while the amplifier circuit 54 is driving the piezoelectric element 38, if the second signal Vix is higher than the reference voltage, the piezoelectric element 38 is in the expansion state, which corresponds to the rising state of the internal pressure of the pump chamber 40. If the second signal Vix is lower than the reference voltage, the piezoelectric element 38 is in the contraction state, which corresponds to the falling state of the internal pressure of the pump chamber 40. Therefore, it shows that the internal pressure of the pump chamber 40 takes the local maximum value at the time point when the second signal Vix is switched from positive to negative with respect to the reference voltage. Further, while the amplifier circuit 54 stops driving the piezoelectric element 38, if the second signal Vix is lower than the reference voltage, the piezoelectric element 38 is in the contraction state, which corresponds to the rising state of the internal pressure of the pump chamber 40. In contrast, if the second signal Vix is higher than the reference voltage, the piezoelectric element 38 is in the expansion state, which corresponds to the falling state of the internal pressure of the pump chamber 40. Therefore, it shows that the internal pressure of the pump chamber 40 takes the local maximum value at the time point when the second signal Vix is switched from negative to positive with respect to the reference voltage.

The pressure variation rate detection section 80 inputs the second signal Vix thus obtained to the comparison section 56. The comparison section 56 compares the second signal Vix with the predetermined threshold voltage Vth to thereby generate the binarized detection signal DS, and input the detection signal DS to the control section 52. The threshold voltage Vth is made to coincide with the voltage (the reference voltage) of the second signal Vix when the variation rate of the internal pressure of the pump chamber 40 is zero. FIG. 6D shows an example of a waveform of the detection signal DS. As shown in FIG. 6D, the detection signal DS includes the plurality of pulses (the first pulse, the second pulse, and so on) due to the pressure oscillation of the pump chamber 40.

The control section 52 is provided with the look-up table LUT. The control section 52 obtains the pressure of the water based on the detection signal DS thus input and the look-up table LUT. Then, the control section 52 displays the pressure value thus obtained on the display section 70 so as to be visually recognized by the user.

### B2. Pressure Measurement

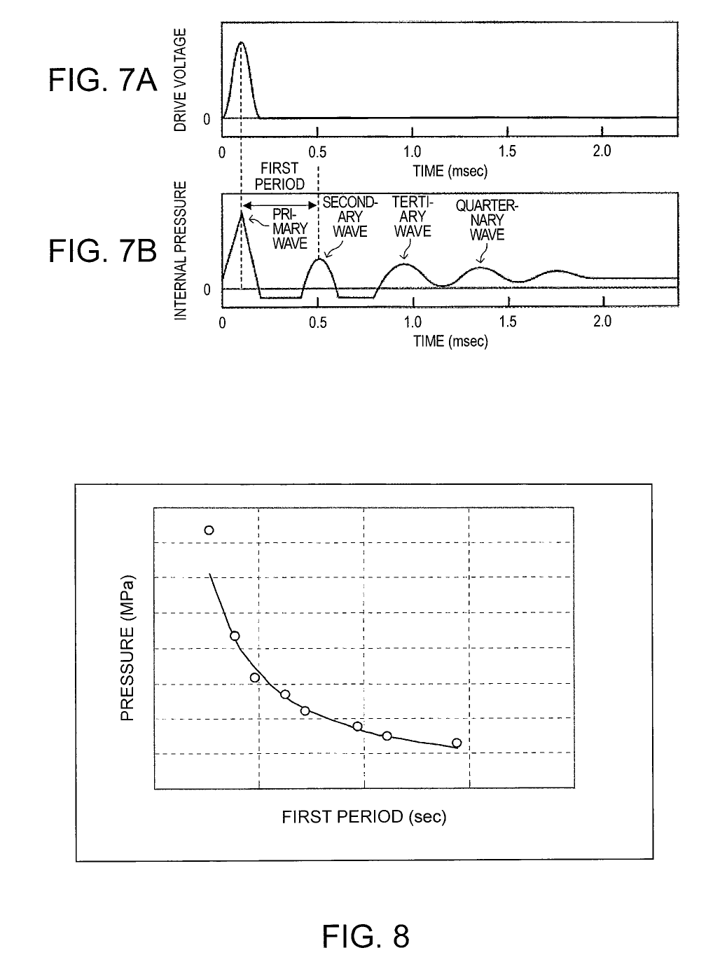

FIGS. 7A and 7B are explanatory diagrams showing an example of the variation in the internal pressure of the pump chamber 40 when applying the drive signal Vout to the piezoelectric element 38. FIG. 7A shows the drive signal Vout to be applied to the piezoelectric element 38. FIG. 7B shows the variation in the internal pressure of the pump chamber 40. Since the variation in the internal pressure of the pump chamber 40 has already been explained in the first embodiment section (FIGS. 3A through 3C), the explanation thereof will be omitted here. Similarly to the first embodiment, also in the present embodiment, a wave of the pressure oscillation, which is composed of single rise and single fall in the internal pressure of the pump chamber 40 due to the application of the drive signal Vout to the piezoelectric element 38, is referred to as a primary wave. The subsequent waves of the pressure oscillation following the primary wave are referred to as a secondary wave, a tertiary wave, a quarternary wave, and so on.

As already explained, the shorter the period (the negative pressure period) from the end of the primary wave of the pressure oscillation of the pump chamber 40 to the generation of the secondary wave is, the higher the pressure of the container 20 is. Therefore, since the period (hereinafter referred to as a “first period”) between the peak point (the local maximum point) of the primary wave of the pressure oscillation and the peak point (the local maximum point) of the secondary wave also includes the negative pressure period, it is conceivable that there is a correlation between the first period and the pressure of the container 20 (see FIG. 7B). FIG. 8 is a diagram showing an actual measurement result showing a relationship between the first period and the pressure in the container 20. In the graph of FIG. 8, the horizontal axis represents the first period, and the vertical axis represents the pressure of the container 20. In the present experiment, the pressure of the container 20 is measured by a pressure gauge disposed separately. As shown in FIG. 8, it is understood that the first period shortens as the pressure of the container 20 rises. In other words, by detecting the first period, the pressure of the liquid Lq (the container 20 in the present embodiment) as the measurement target can be detected.

The control section 52 measures the first period from when the pressure wave of the liquid Lq, which occurs when the diaphragm 36 and the piezoelectric element 38 are in operation in the state in which the liquid Lq is contained in the flow channel 34 and the pump chamber 40, becomes a first peak to the next time the pressure wave becomes a second peak with the same polarity as the first peak, and then obtains the pressure of the liquid Lq based on the first period. In the present embodiment, the pressure measurement device 30 has the look-up table LUT corresponding to the graph shown in FIG. 8 explained above stored in the control section 52 (see FIG. 5). In other words, the control section 52 is provided with the look-up table LUT including the values of the first period and the values based on the actual measurement of the pressure of the measurement target corresponding to each other. When actually measuring the pressure of the liquid Lq as the measurement target, the control section 52 applies a pulse of drive signal Vout to the piezoelectric element 38 to thereby generate the pressure oscillation in the pump chamber 40, and then extracts the first period from the detection signal DS thus detected. Then, the control section 52 inputs the first period thus obtained to the look-up table LUT. The control section 52 obtains the value of the pressure output from the look-up table LUT in correspondence with the first period. The first period corresponds to the period of time from when the first pulse of the detection signal DS is detected to when the detection of the first pulse ends (see FIG. 6D).

Subsequently, the control section 52 displays the value of the pressure thus obtained on the display section 70 so as to be visually recognized by the user. It is also possible to arrange that the control section 52 is provided with look-up tables LUT with respect to a variety of types of liquids such as water, predetermined oil, or a predetermined organic solvent. This can be realized by actually measuring the correlation between the first period and the pressure of the liquid Lq as the measurement target to make the look-up table LUT with respect to each of the liquids.

As described hereinabove, the pressure measurement device 30 according to the second embodiment can measure the pressure of the liquid Lq as the measurement target using the resonance of the pressure oscillation between the container 20 and the pump chamber 40 similarly to the first embodiment. As described above, since the internal pressure of the pump chamber 40 is kept at the saturated vapor pressure of the liquid Lq, it results that the relative pressure from the saturated vapor pressure is measured in the “negative pressure period” which varies in accordance with the difference from the pressure of the liquid Lq as the measurement target. Therefore, since the “negative pressure period” does not depend on the characteristic variation of the piezoelectric element, the calibration of the piezoelectric element is not required. Further, the pressure measurement can be performed with a simple structure. As a result, it is possible to obtain a configuration, which is hardly affected by the variation in external environment of the pressure measurement device 30 such as external dust or the temperature variation when measuring the pressure, and has high durability. Therefore, the pressure measurement device 30 is capable of performing the pressure measurement even in a relatively poor measurement environment, and can therefore be made to be a pressure gauge most suitable for industrial use. For example, a tank for industrial use for containing a liquid, and a pipe as a flow channel of a liquid for industrial use are normally provided with a through hole for inserting a thermometer or a through hole for drain evacuation. By connecting the flow channel 34 of the pressure measurement device 30 to such through holes, it becomes possible to measure the pressure in the tank or the pipe. Further, in the present embodiment, since the single piezoelectric element 38 performs the application of the pressure to the pump chamber 40 and the measurement of the internal pressure of the pump chamber 40, simplification of the structure, downsizing, and cost reduction can be realized compared to the case of performing the above by separate elements or devices, respectively.

Further, in the pressure measurement device 30 according to the second embodiment, when applying the drive signal Vout to the piezoelectric element 38, the electrical potential difference between the terminals of the resistor r becomes zero by setting the switch sw to the ON state (in reality, a slight electrical potential difference might be generated due to the ON resistance of the switch sw). Therefore, the electrical potential difference between the terminals of the piezoelectric element 38 roughly coincides with the voltage of the drive signal Vout, and it is possible to flow the drive current Iout through the piezoelectric element 38 without a waste. Further, after applying the drive signal Vout to the piezoelectric element 38, the first signal Vi corresponding to the electrical potential difference between the terminals of the resistor r can be obtained by setting the switch sw to the OFF state. Therefore, according to the pressure measurement device 30 of the second embodiment, it is possible to reduce the drive loss of the piezoelectric element 38 irrespectively of the resistance value of the resistor r to thereby improve the power consumption efficiency, and at the same time, by increasing the resistance value of the resistor r, the detection S/N ratio can be improved.

### C. Modified Examples

It should be noted that the invention is not limited to the embodiments described above, but can be put into practice in various forms within the scope or the spirit of the invention, and the following modifications, for example, are also possible.

### C1. Modified Example 1

Although in each of the embodiments described above, it is assumed that the pressure of the water contained in the container 20 is measured, the invention is not limited to the case in which the liquid Lq as the measurement target is contained in a sealed container, but it is also possible to arrange that the liquid Lq is contained in a pipe or an open container. Even in such a case, the pressure measurement device 30 can measure the pressure of the liquid Lq.

### C2. Modified Example 2

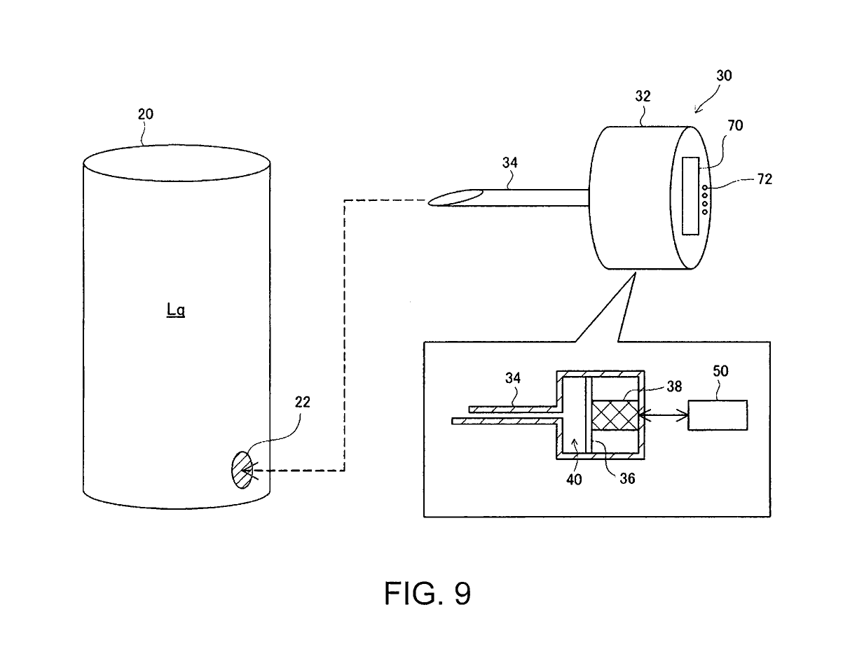

The configuration of the pressure measurement device 30 is not limited to the configuration shown in FIG. 1, but a variety of configurations can be adopted. FIG. 9 is an explanatory diagram showing a configuration of a pressure measurement device as a modified example 2. As shown in the drawing, the tip of the flow channel 34 has a sharp shape, and thus, the configuration is arranged to be stuck into the container 20 when used. The container 20 containing the liquid Lq as the measurement target is provided with an insertion section 22 in which the flow channel 34 is stuck to communicate with the inside of the container 20. The insertion section 22 is formed of a rubber member with a thick wall. The hole in the insertion section 22 formed after pulling out the flow channel 34 is choked with the elastic force of the rubber member.

As shown in the drawing, the pressure measurement device 30 has the display section 70 and a variety of operation buttons 72 such as a start button for starting the measurement or an operation button for instructing recording of the measurement value. On the display section 70, the value of the pressure thus measured is displayed so as to be visually recognized by the user. By providing the pressure measurement device 30 with such a configuration, the user can easily measure the pressure of the liquid Lq contained in the container 20.

### C3. Modified Example 3

Although in each of the embodiments described above, the piezoelectric element 38 causes the pressure oscillation, and at the same time measures the internal pressure of the pump chamber 40, it is also possible to use separate piezoelectric elements for the respective purposes. In other words, it is also possible to arrange that the pressure measurement device 30 is separately provided with the piezoelectric element as the pressure difference generation section and the piezoelectric element as the measurement section, respectively. Further, although in each of the embodiments described above, the piezoelectric element is adopted as the pressure difference generation section, it is also possible to arrange that an element or a device capable of causing the pressure difference between the pump chamber 40 and the container 20 such as a magnetostrictor is used instead of the piezoelectric element. The magnetostrictor provides a large displacement due to the distortion, and can therefore cause a larger amplitude pressure oscillation. According also to this configuration, substantially the same advantages as in each of the embodiments can be obtained.

### C4. Modified Example 4

Although in each of the embodiments, it is assumed that the pressure of the liquid Lq is obtained from the negative pressure period T or the first period using the look-up table LUT, it is also possible to arrange that the pressure is obtained using other methods. For example, it is also possible to arrange that a predetermined function representing the correlation between the negative pressure period T shown in the graph of FIG. 4 or the first period, and the pressure is used. This can be realized by the control section 52 substituting the negative pressure period T or the first period into the predetermined function to calculate the pressure of the liquid Lq.

### C5. Modified Example 5

Although in each of the embodiments described above, it is assumed that the pressure of the liquid Lq, which can be measured using the negative pressure period T, is the relative pressure from the saturated vapor pressure of the liquid Lq, it is also possible to measure the absolute pressure of the liquid Lq by obtaining the saturated vapor pressure of the liquid Lq in advance.

### C6. Modified Example 6

Although in each of the embodiments described above, water is adopted as the liquid Lq, the liquid Lq is not limited to water, but a variety of liquids such as predetermined oil (e.g., silicone oil) or a predetermined organic solvent (e.g., alcohol) can be adopted. In this case, the invention can be realized by providing the control section 52 with the look-up tables LUT with respect to a variety of types of liquids such as predetermined oil or a predetermined organic solvent in addition to water.

### C7. Modified Example 7

Although in each of the embodiments described above, the piezoelectric element 38 and the diaphragm 36 are adopted as the pressure changing section, the pressure changing section is not limited to these components. It is possible to adopt a variety of configurations capable of changing the pressure of the pump chamber 40. For example, it is also possible to arrange that the pressure of the pump chamber 40 is changed by externally injecting the liquid into the pump chamber 40. Besides the above, it is also possible to arrange that a laser emission section is disposed inside the pump chamber 40, a bubble is generated by irradiating water in the pump chamber 40 with the laser, and the pressure is changed by the bubble. According also to this configuration, substantially the same advantages as in each of the embodiments can be obtained.

### C8. Modified Example 8

Although in the second embodiment, it is arranged that the resistor r and the switch sw are connected in parallel to each other between the terminal of the piezoelectric element 38 and the ground, and the current flowing through the piezoelectric element 38 flows through the resistor r when the switch sw is in the ON state, it is also possible to arrange that the resistor r and the switch sw are connected in series to each other between the terminal of the piezoelectric element and the ground, and the current flowing through the piezoelectric element 38 flows through the resistor r when the switch sw is in the OFF state.

### C9. Modified Example 9

Although in each of the embodiments described above, the pressure oscillation is generated by applying the drive signal Vout as a positive pulse to the piezoelectric element 38 to expand the piezoelectric element 38 to thereby raise the internal pressure of the pump chamber 40, it is also possible to generate the pressure oscillation by applying the drive signal Vout as a negative pulse to the piezoelectric element 38 to contract the piezoelectric element 38 to thereby drop the internal pressure of the pump chamber 40.

### C10. Modified Example 10

Although in each of the embodiments, the pressure of the liquid Lq is obtained from the negative pressure period T or the first period using the look-up table LUT, the invention is not limited to this configuration. It is also possible to arrange that the piezoelectric element 38 and the drive circuit 50 measure the behavior of the liquid in the liquid containing chamber in a period other than the negative pressure period T or the first period, and the drive circuit 50 (the control section 52) obtains the pressure of the liquid Lq using the measurement result. As the behavior of the liquid in the period other than the negative pressure period T or the first period, there can be adopted a variety of parameters related to the liquid such as a pressure wave, a flow rate, a flow velocity, or the mobility of the liquid.

### D1. Application Example 1

By applying the pressure measurement device 30 according to the invention to a liquid treatment device such as a water purification device, a water demineralizer, or an effluent treatment device, the pressure can be measured at low cost, and therefore, the low-cost liquid treatment device can be provided.

It should be noted that the embodiments and the modified examples described above are illustrative only, and the invention is not at all limited to these embodiments and the examples. For example, it is also possible to arbitrarily combine the embodiments and the modified examples described above with each other.

The invention includes configurations (e.g., configurations having the same function, the same way, and the same result, or configurations having the same object and the same advantage) substantially the same as any of the configurations described as the embodiments of the invention. Further, the invention includes configurations obtained by replacing a non-essential part of the configuration described as the embodiments of the invention. Further, the invention includes configurations exerting the same functional effects and configurations capable of achieving the same object as any of the configurations described as the embodiments of the invention. Further, the invention includes configurations obtained by adding known technologies to any of the configurations described as the embodiments of the invention.

What is claimed is:

1. A pressure measurement device adapted to measure a pressure of a liquid, comprising:
a flow channel having a flow channel resistance;
a liquid containing chamber having a predetermined capacity and communicating with the flow channel;
a pressure changing section adapted to change a pressure of the liquid containing chamber;
a measurement section adapted to measure a period from when a pressure wave of the liquid in the liquid containing chamber becomes a predetermined value to next time the pressure wave becomes the predetermined value, the pressure wave occurring when the pressure changing section is in operation in a state in which the liquid is contained in the flow channel and the liquid containing chamber; and
an acquisition section adapted to obtain the pressure of the liquid based on the period measured by the measurement section.

2. The pressure measurement device according to claim 1, wherein
the pressure changing section includes a piezoelectric element, and changes the pressure of the liquid containing chamber due to a force caused by a distortion of the piezoelectric element.

3. The pressure measurement device according to claim 2, wherein
the piezoelectric element is further distorted due to a pressure variation of the liquid containing chamber, and
the measurement section measures the period based on the distortion of the piezoelectric element.

4. The pressure measurement device according to claim 2, wherein
the measurement section drives the piezoelectric element, detects a current flowing through the piezoelectric element, and measures the period based on the current flowing through the piezoelectric element.

5. The pressure measurement device according to claim 4, wherein
the measurement section stops detecting the current flowing through the piezoelectric element while driving the piezoelectric element, and then detects the current flowing through the piezoelectric element after stopping driving the piezoelectric element.

6. The pressure measurement device according to claim 5, wherein
the measurement section includes
a resistor circuit adapted to measure the current flowing through the piezoelectric element, and
a switch circuit adapted to control whether or not the current flowing through the piezoelectric element is made to flow through the resistor circuit.

7. The pressure measurement device according to claim 1, wherein
the liquid is contained in a container,
the liquid containing chamber communicates with one end of the flow channel, and
the other end of the flow channel is connected to the container.

8. The pressure measurement device according to claim 7, wherein
the other end of the flow channel is detachably connected to the container.

9. A pressure measurement device adapted to measure a pressure of a liquid, comprising:
a flow channel having a flow channel resistance;
a liquid containing chamber having a predetermined capacity and communicating with the flow channel;
a pressure changing section adapted to change a pressure of the liquid containing chamber;
a measurement section adapted to measure a period from when a pressure wave of the liquid in the liquid containing chamber becomes a first peak to next time the pressure wave becomes a second peak with a same polarity as the first peak, the pressure wave occurring when the pressure changing section is in operation in a state in which the liquid is contained in the flow channel and the liquid containing chamber; and
an acquisition section adapted to obtain the pressure of the liquid based on the period measured by the measurement section.

10. The pressure measurement device according to claim 9, wherein
the pressure changing section includes a piezoelectric element, and changes the pressure of the liquid containing chamber due to a force caused by a distortion of the piezoelectric element.

11. The pressure measurement device according to claim 10, wherein
the piezoelectric element is further distorted due to a pressure variation of the liquid containing chamber, and
the measurement section measures the period based on the distortion of the piezoelectric element.

12. The pressure measurement device according to claim 10, wherein
the measurement section drives the piezoelectric element, detects a current flowing through the piezoelectric element, and measures the period based on the current flowing through the piezoelectric element.

13. The pressure measurement device according to claim 12, wherein
the measurement section stops detecting the current flowing through the piezoelectric element while driving the piezoelectric element, and then detects the current flowing through the piezoelectric element after stopping driving the piezoelectric element.

14. The pressure measurement device according to claim 13, wherein
the measurement section includes
a resistor circuit adapted to measure the current flowing through the piezoelectric element, and
a switch circuit adapted to control whether or not the current flowing through the piezoelectric element is made to flow through the resistor circuit.

15. The pressure measurement device according to claim 9, wherein
the liquid is contained in a container,
the liquid containing chamber communicates with one end of the flow channel, and
the other end of the flow channel is connected to the container.

16. The pressure measurement device according to claim 15, wherein
the other end of the flow channel is detachably connected to the container.

17. A liquid treatment device comprising
the pressure measurement device according to claim 1.
